(19) United States
(12) Patent Application Publication
(10) Pub. No.: US 2024/0086451 A1
(43) Pub. Date: Mar. 14, 2024

(54) INFORMATION PROCESSING APPARATUS, RECEPTION APPARATUS, INFORMATION PROCESSING METHOD, AND STORAGE MEDIUM

(71) Applicant: CANON KABUSHIKI KAISHA, Tokyo (JP)

(72) Inventor: Toru Suneya, Kanagawa (JP)

(21) Appl. No.: 18/233,399

(22) Filed: Aug. 14, 2023

(30) Foreign Application Priority Data
Sep. 13, 2022 (JP) 2022-145570

(51) Int. Cl. G06F 16/438; G06T 13/80

(52) U.S. Cl. CPC G06F 16/4387; G06T 13/80

(57) ABSTRACT

There is provided with an information processing apparatus. A generation unit generates a playlist including a network address to be referenced in order to acquire first media data and second media data to be reproduced subsequently to the first media data and transition effect information indicating a first transition effect to be applied to a display or audio when switching reproduction of the first media data and the second media data. A transmission unit transmits the playlist to the reception apparatus.

### BACKGROUND OF THE INVENTION

### Field of the Invention

The present invention relates to an information processing apparatus, a reception apparatus, an information processing method, and a storage medium.

### Description of the Related Art

There are systems in which content in a streaming format composed of audio data, video data, and the like is distributed in real time, and a user views such content on their terminal apparatus. At this time, since terminal apparatuses have various capabilities and content is reproduced in various environments, a technology for adapting to the environment of content reproduction is required. There is a technology in which, when distributing a content such as an image or audio, a file called a playlist in which network addresses for the content is described is distributed, and thereby the reception apparatus reproduces the content.

Japanese Patent Laid-Open No. 2019-211706 discloses a technology of distributing a still image stored in a HEIF file as a DASH segment in order to distribute still images, which have not been envisioned to be distributed in MPEG-DASH (Dynamic Adaptive Streaming over HTTP).

### SUMMARY OF THE INVENTION

According to one embodiment of the present disclosure, an information processing apparatus comprises: a generation unit configured to generate a playlist including a network address to be referenced in order to acquire first media data and second media data to be reproduced subsequently to the first media data and transition effect information indicating a first transition effect to be applied to a display or audio when switching reproduction of the first media data and the second media data; and a transmission unit configured to transmit the playlist to the reception apparatus.

According to another embodiment of the present disclosure, a reception apparatus, comprises: a reception unit configured to receive a playlist including a network address to be referenced in order to acquire first media data and second media data to be reproduced subsequently to the first media data and transition effect information indicating a transition effect to be applied to a display or audio when switching reproduction of the first media data and the second media data; and an acquisition unit configured to acquire, based on the network address, the first media data and the second media data; and a reproduction unit configured to, based on the received playlist, perform reproduction of the acquired first media data and second media data.

Further features of the present invention will become apparent from the following description of exemplary embodiments (with reference to the attached drawings).

### BRIEF DESCRIPTION OF THE DRAWINGS

FIG. 1 is a diagram illustrating an example of a system including an information processing apparatus according to a first embodiment.

FIG. 2 is a diagram illustrating an example of a functional configuration of an information processing apparatus according to a first embodiment.

FIG. 3 is a flowchart illustrating an example of information processing according to a first embodiment.

FIG. 4 is a diagram illustrating an example of a playlist that the information processing apparatus according to a first embodiment generates.

FIGS. 5A and 5B are diagrams illustrating an example of a playlist that the information processing apparatus according to a first embodiment generates.

FIG. 6 is a diagram illustrating an example of a playlist that the information processing apparatus according to a first embodiment generates.

FIG. 7 is a diagram illustrating an example of a playlist that the information processing apparatus according to a second embodiment generates.

FIG. 8 is a diagram illustrating an example of a playlist that the information processing apparatus according to a third embodiment generates.

FIG. 9 is a diagram illustrating an example of a playlist that the information processing apparatus according to a third embodiment generates.

FIG. 10 is a diagram illustrating an example of a playlist that the information processing apparatus according to a fourth embodiment generates.

FIG. 11 is a flowchart illustrating an example of information processing according to a fifth embodiment.

FIG. 12 is a diagram illustrating an example of a functional configuration of a reception apparatus according to a fifth embodiment.

FIG. 13 is a diagram illustrating an example of a hardware configuration of an information processing apparatus and a reception apparatus.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

When the content is continuously reproduced using such a playlist, there is a problem that when the content to be reproduced is switched, even if a transition effect is wished to be applied to the reproduced display or the audio, the transition effect cannot be defined.

An embodiment of the present invention provides an information processing apparatus that includes information on a transition effect to be applied when media data is switched in a playlist including a network address that is referenced to acquire a plurality of pieces of media data.

The information processing apparatus according to the first embodiment generates a playlist and transmits the generated playlist to the reception apparatus. The playlist according to the present embodiment includes network addresses that are referenced to acquire first media data and second media data to be reproduced subsequently to the first media data. Furthermore, the playlist according to the present embodiment also includes transition effect information indicating a transition effect to be applied to a display or audio when the reproduction of the first media data and the second media data is switched. Here, the transition effect is assumed to be, for example, a “wipe” effect in which an image appears from a predetermined direction, which is applied to the display or audio when the media data to be reproduced is switched, and will be described in detail later.

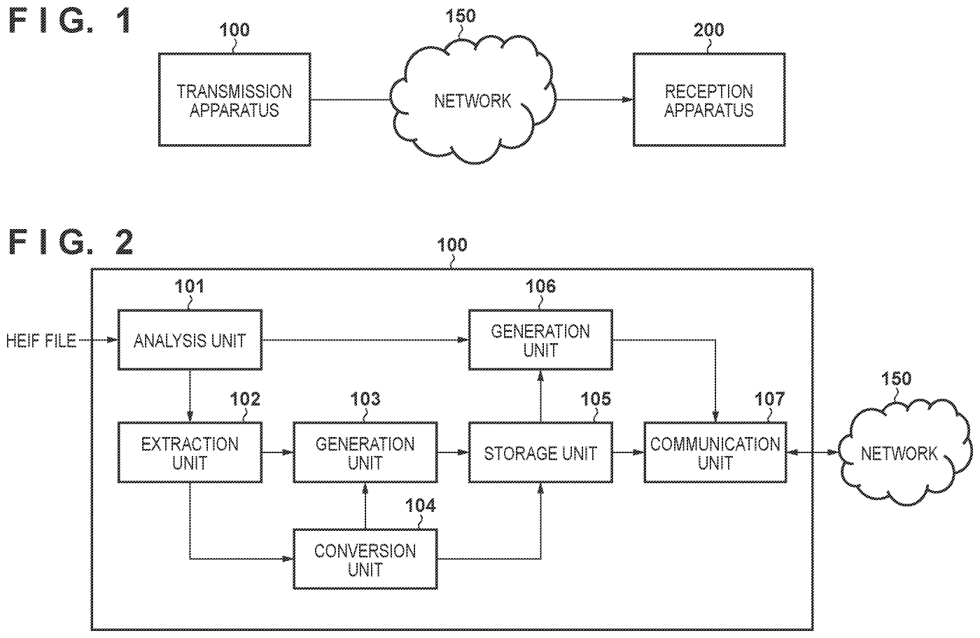

FIG. 1 is a diagram illustrating an example of a configuration of a system including an information processing apparatus according to the present embodiment. An information processing apparatus 100 according to the present embodiment is connected to a reception apparatus 200 via a network 150 so as to be able to communicate, and transmits the above-described playlist to the reception apparatus 200. The information processing apparatus 100 may be, for example, a camera, a video camera, a mobile terminal such as a smart phone, a personal computer (PC), a cloud server, or the like, but is not particularly limited as long as the respective functions described below can be executed.

The reception apparatus 200 receives data transmitted from the information processing apparatus 100. The reception apparatus 200 according to the present embodiment may reproduce content (display an image or reproduce audio), may perform communication, and may receive input from a user. As the reception apparatus 200 according to the present embodiment, a desired electronic device such as a mobile terminal such as a smart phone, a PC, or a TV can be used.

As the network 150 according to the present embodiment, a wired Local Area Network (LAN) or a wireless LAN is assumed to be used, but the network is not particularly limited as long as a connection between the information processing apparatus 100 and the reception apparatus 200 is established. For example, the network 150 may be a Wide Area Network (WAN), such as 3G/4G/LTE, or an ad hoc network, such as Bluetooth®. In the present embodiment, description is given assuming that there are one information processing apparatus 100 and one reception apparatus 200, but there may be a plurality of each.

In the present embodiment, a standard called Moving Picture Experts Group (MPEG)-Dynamic Adaptive Streaming over Http (DASH) of ISO/IEC 23009-1 is used. Further, processes such as those for the generation of a playlist, which will be described later, are described as being performed using the standard of MPEG-DASH.

The standard of Moving Picture Experts Group (MPEG)-Dynamic Adaptive Streaming over Http (DASH) will be described below. MPEG-DASH is a video distribution standard that enables dynamic changing of the stream to be acquired.

In MPEG-DASH, media data may be divided into segments of a predetermined length of time, and network addresses for acquiring segments may be described in a file called a playlist. The reception apparatus 200 can receive the playlist and make a request to the information processing apparatus to acquire a desired segment using the information described in the playlist. Further, by describing network addresses for segments of a plurality of versions having different bit rates, resolutions, and the like in the playlist, the reception apparatus 200 can acquire a segment of an optimal version according to its own capabilities, communication environment, and the like. ISO Base Media File Format (hereinafter referred to as ISOBMFF) is used as the file format of the segment.

Here, the description below will assume that a network address included in the playlist is basically a Uniform Resource Locator (URL). Note that a generation unit 106 described later may describe a Uniform Resource Identifier (URI) as a network address and may describe an IP address of the Internet or a LAN, and is not particularly limited as long as the location of the data can be described.

An ISOBMFF configuration is broadly divided into a portion for storing header information and a portion for storing encoded data, and the header information includes information indicating a size and a time stamp of encoded data to be stored in the segment, and the encoded data can include a moving image, a still image, audio data, and the like. In ISOBMFF, a plurality of enhanced standards exist depending on the type of encoded data to be stored, and one of the enhanced standards is High Efficiency Image File Format (HEIF), which was standardized by the MPEG. HEIF has been standardized in ISO/JEC 23008-12 (Part 12) under the name “Image File Format” and defines specifications for the storage of still images and image sequences encoded in High Efficiency Video Coding (HEVC), which is a codec mainly used for moving images. In addition to media data such as moving images, ISOBMFF can store metadata such as text and XML, and such metadata can be stored not only as static information but also as dynamic information. In particular, metadata having information in time series is referred to as timed metadata, and specific examples include subtitle data.

Next, with reference to FIG. 2, information processing performed by the information processing apparatus 100 according to the present embodiment will be described. FIG. 2 is a block diagram illustrating an example of a functional configuration of the information processing apparatus 100. The information processing apparatus 100 according to the present embodiment includes an analysis unit 101, an extraction unit 102, a generation unit 103, a conversion unit 104, a storage unit 105, the generation unit 106, and a communication unit 107.

The analysis unit 101 analyzes the structure of the data file. Hereinafter, the description will assume that the data file analyzed by the analysis unit 101 is in the HEIF file format. The extraction unit 102 extracts metadata and encoded data stored in the data file based on the result of analyzing the data file by the analysis unit 101.

The generation unit 103 divides the metadata and the encoded data extracted by the extraction unit 102 into time lengths suitable for communication as needed, changes the bit rate, and the like, and generates segments in which the data is stored. The conversion unit 104 may convert the extracted encoded data into different encoding formats as necessary. The generation unit 103 may store encoded data subjected to conversion by the conversion unit 104 in a segment. The storage unit 105 stores data generated by the generation unit 103.

Based on the result of analyzing the data file, the generation unit 106 generates a playlist including a network address to be referenced by the reception apparatus 200 to acquire the data stored in the storage unit 105. The playlist according to the present embodiment includes a network address that is referenced to acquire first media data and a network address that is referenced to acquire second media data. The communication unit 107 transmits the playlist generated by the generation unit 106 to the reception apparatus 200.

Network addresses according to the present embodiment are referenced to acquire media data. For example, the information processing apparatus 100 can acquire an image (a still image or a moving image) or audio as media data by referencing a URL that is a network address. In the following description, for the sake of explanation, still image media data will be referred to as an “image” and moving image media data will be referred to as a “moving image”.

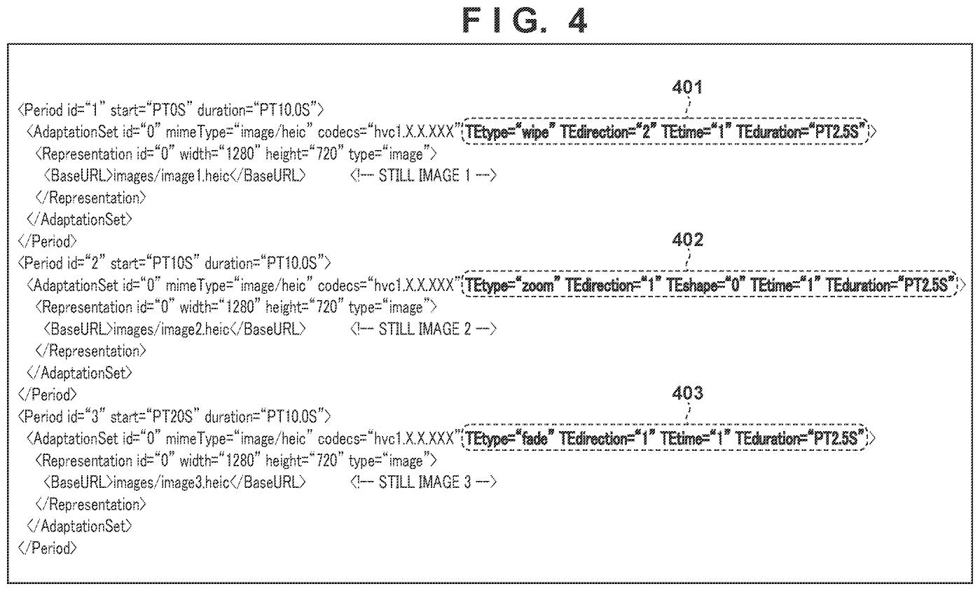

In a playlist according to the present embodiment, order information indicating the order of reproduction of a plurality of pieces of media data is described. In the example of FIG. 4, which will be described later, URLs for the media data are described in the order in which the media is to be reproduced, and thereby the order of reproduction of the media data is determined in accordance with that order. In the following description, the media data that ends the reproduction in accordance with the order of the reproduction will be referred to as “end” media data, and the media data that starts the next reproduction will be referred to as “start” media data. Here, when the media data is an image, the end media data is referred to as an “end image”, and the start media data is referred to as a “start image”.

Furthermore, the playlist according to the present embodiment also describes transition effect information indicating a transition effect to be applied to a display or audio when the reproduction of media data is switched. Here, as the transition effect, for example, when the media data is an image, a “wipe” which is a transition effect in which the start image appears from a predetermined direction (or the end image disappears in a predetermined direction) is given as an example. Further, for example, the transition effect may be a “zoom”, which is a transition effect in which, when the media data is an image, the start image is reproduced while being enlarged (or the reproduction is ended while shrinking the end image). Further, for example, the transition effect includes “fade”, which is a transition effect in which, when the media data is an image, the start image is reproduced while fading in (or the reproduction is ended while fading out the end image). Here, it is assumed that the type of transition effect is specified in a TEtype term in descriptions 401 to 403 of FIG. 4, which will be described later, and the transition effect types for wipe, zoom, and fade are specified in the cases where TEtype=“wipe”, TEtype=“zoom”, and TEtype=“fade” respectively. Note that the same transition effect as that of an image can be applied even when the media data is a moving image.

Further, for example, as the transition effect, in a case where the media data is audio, there is “fade” in which the audio is reproduced such that the start audio gradually gets louder from silence (the end audio gradually gets quieter). By defining a fade, it is possible to perform a crossfade (which may be an image) or the like for gradually reproducing the next audio while fading the audio.

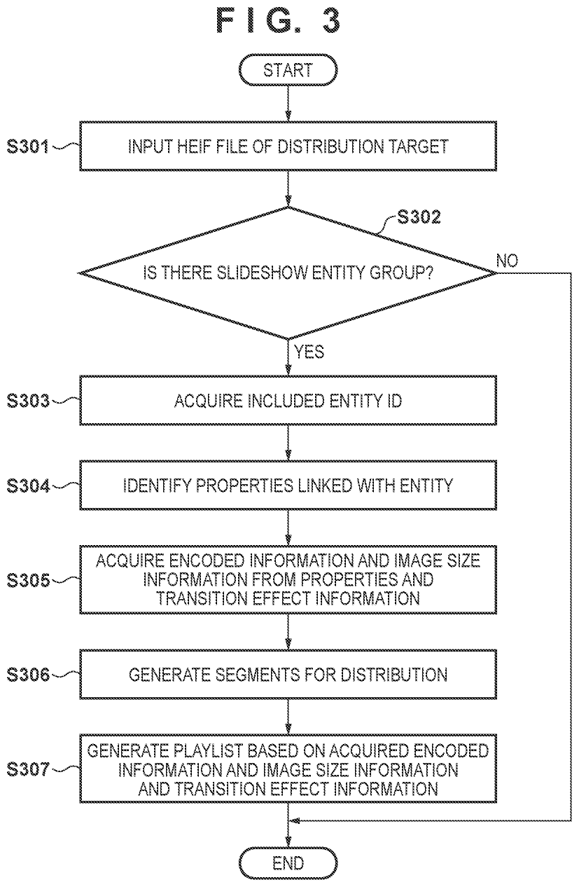

FIG. 3 is a diagram illustrating an exemplary process performed by the information processing apparatus 100 according to the present embodiment for analyzing an inputted HEIF file to generate a playlist. In MPEG-DASH, a file corresponding to a playlist is called a Media Presentation Description (MPD).

In step S301, the information processing apparatus 100 acquires a HEIF file to be analyzed. Here, the information processing apparatus 100 acquires a HEIF file from, for example, an imaging apparatus (not illustrated). In step S302, the analysis unit 101 determines whether or not the file includes information to which a transition effect is to be applied. Here, it is assumed that the analysis unit 101 determines whether or not a slideshow entity group in which information related to a slideshow is stored exists in a file. If there is a slideshow entity group, the process proceeds to step S303, otherwise the process ends.

Content stored as an image in a HEIF file is referred to as an item, content stored as a moving image (image sequence) is referred to as a track, and content including both an item and a track is referred to as an entity. A slideshow entity group is metadata for identifying a group of items displayed in a slideshow among the entities stored in a HEIF file.

In step S303, the analysis unit 101 analyzes the HEIF file to acquire an entity ID which is an identifier of a respective entity included in the file and an item ID which is an identifier of a respective item (including media data).

In step S304, the analysis unit 101 identifies a property linked with an entity and an item whose ID is acquired, and in the subsequent step S305, the analysis unit 101 acquires the identified property. Here, it is assumed that the analysis unit 101 acquires encoded information, image size information, and information on transition effects as properties linked with the respective entities. The analysis unit 101 can acquire information indicating the association between information stored in a box ipco and an entity ID and an item ID by referencing a box ipma included in the HEIF file, for example, and can acquire respective properties.

In step S306, the generation unit 103 generates a distribution segment. Here, assuming a sequence in which a plurality of images are sequentially displayed in a slideshow, the generation unit 103 stores each of the plurality of files in a separate HEIF file.

In step S307, the generation unit 106 generates a playlist based on the properties acquired in step S305. When there are a plurality of slideshow entity groups in one HEIF file, the generation unit 306 may create a playlist for each slideshow entity group, or may collectively describe them in one playlist.

Here, assume that the processing is ended without generating a playlist in a case where a slideshow entity group does not exist in a file, but configuration may be such that a playlist that does not apply a transition effect may be generated even in such case.

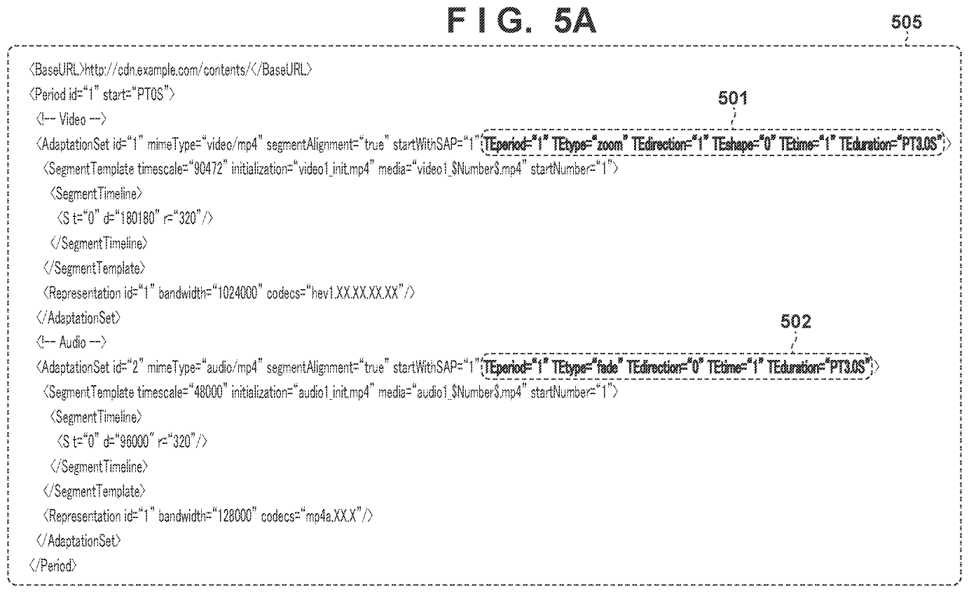

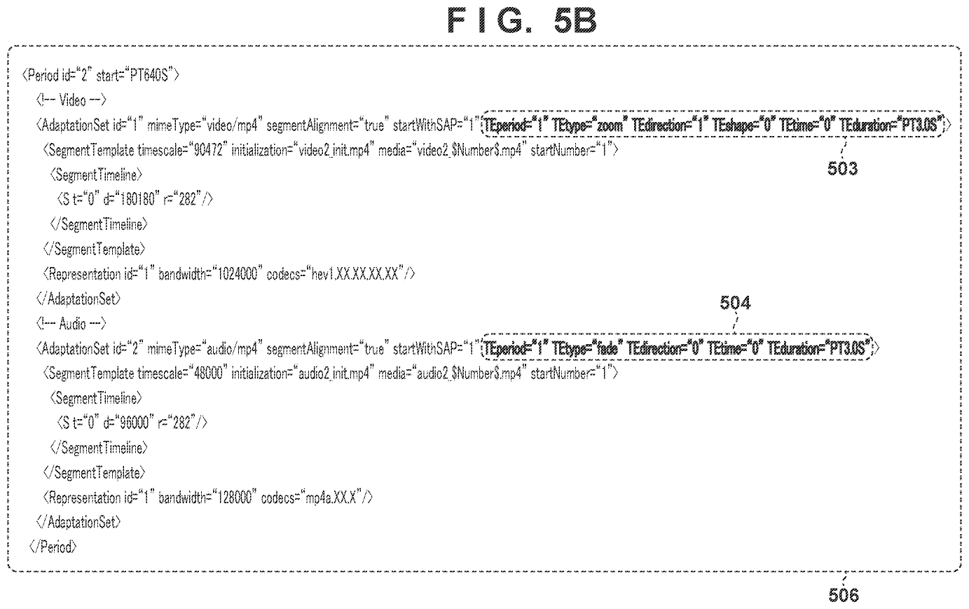

Next, with reference to FIG. 4 and FIGS. 5A and 5B, a playlist generated by the generation unit 106 will be described. FIG. 4 is a diagram that illustrates an example of a portion of a description of a playlist generated by the generation unit 106.

In the playlist illustrated in FIG. 4, URLs corresponding to three images (file names image1.heic, image2.heic, image3.heic) to be reproduced are described in the order in which they are to be reproduced. Here, each of the three images is to be reproduced for 10 seconds, and then the reproduction is switched to the next image. In the example of FIG. 4, descriptions 401 to 403, which are transition effect information, are respectively described in three images, and the type of transition effect and attributes of the transition effect are defined by the description. Here, the attributes of the transition effect are information indicating settings for when the transition effect is applied, for example, a timing at which the transition effect is to be applied.

Hereinafter, the attributes of the transition effect will be described. A parameter is described for each item indicating an attribute of each transition effect, and a setting corresponding to the parameter is performed. The description 401 is a description in which TEtype=“wipe” is described as the type of the transition effect. In the description 401, as attributes of the transition effect, item TEdirection indicating a direction in which the start image appears (and the end image disappears) in the wipe, item TEtime indicating a timing at which the transition effect is applied, and item TEduration indicating a period over which the transition effect is applied are described. Here, it is assumed that the direction in which the start image appears in the wipe is set to right by the description of TEdirection=“1”, and is set to left by the description of TEdirection=“2”. Further, when the transition effect is to be applied at the start of reproduction of the corresponding image (image1.heic), TEtime=“0” is described, when the transition effect is applied at the end of reproduction of the corresponding image, TEtime=“1” is described, and when the transition effect is applied at both the start of reproduction and the end of reproduction, TEtime=“2” is described. In addition, a period over which the transition effect is to be applied is set in accordance with the parameter of the TEduration item of the transition effect, and the transition effect to be applied is 2.5 seconds according to TEduration=“PT2.5S. That is, image1.heic which is to be the start image appears in the screen in the wipe for 2.5 seconds.

The description 402 is a description in which TEtype=“zoom” is described as the type of the transition effect. In the description 402, item TEdirection indicating a direction in which the start image is enlarged by zooming (in which the end image is reduced), TEtime, item TEshape indicating the shape of the outer frame when the start image appears by zooming, and TEduration are described as transition effect attributes. Here, it is assumed that the start point for the image being enlarged by zooming is set to the upper left end by the description of TEdirection=“1”, and is set to the lower left end by the description of TEdirection=“2”. Further, it is assumed that the above-described outer frame is set to be rectangular when TEshape=“1”, and is set to be circular when TEshape=“2”.

The description 403 is a description in which TEtype=“fade” is described as the type of the transition effect. In the description 403, TEdirection, TEtime, and TEduration are described as attributes of the transition effect. Here, the item TEdirection is used as an item for specifying a background color when an end image is faded out in the fade. As described above, the attributes specified by the respective items need not be unified, and different settings may be made for the respective attributes of the transition effect.

When TEduration (the period over which the transition effect is applied) and the like is the same for all attributes of the transition effect, for example, a common value may be made to be a default and description thereof may be omitted. Further, the parameters in FIG. 4 described above are only examples, and different settings may be made according to the same value.

When a moving image or audio is used as the media data, a segment obtained by dividing one piece of media data into a predetermined time length may be used as the media data corresponding to each URL. However, it is also conceivable that a frequency at which a transition effect is applied will be excessive when applying the transition effect to each segment (for example, which is divided every few seconds). In consideration of this, the information processing apparatus 100 can apply the transition effect to respective content including a plurality of pieces of media data to apply the transition effect at a more effective timing.

FIGS. 5A and 5B is a diagram that illustrates an example of a portion of a description of a playlist generated by the generation unit 106. Although an image is used as the media data in FIG. 4, the media data in FIGS. 5A and 5B are a moving image and audio. In FIGS. 5A and 5B, content 505 and content 506 are described. Here, a period is specified for each of the content 505 and the content 506, and descriptions 501 to 504 regarding transition effects during the periods are described.

The content 505 and the content 506 in FIGS. 5A and 5B are content for reproducing moving images and audio, respectively. In the content 505, the URL of the file name video1_init.mp4 and the description 501 of the transition effect thereof are described as a moving image, and the URL of the file name audio1_init.mp4 and the description 502 of the transition effect thereof are described as audio. In the content 506, the URL of the file name video2_init.mp4 and the description 503 of the transition effect thereof are described as a moving image, and the URL of the file name audio2_init.mp4 and the description 504 of the transition effect thereof are described as audio.

The description 501 is a description including the description TEtype=“zoom” as the type of the transition effect. In the description 501, TEperiod, indicating the timing at which the transition effect is to be applied with respect to the reproduction period of the content, TEdirection, TEshape, and TEduration are described as the attributes of the transition effect. Here, TEperiod=“0” is described when the transition effect is applied at the start of the reproduction period of the content, TEperiod=“1” is described when the transition effect is applied at the end of the reproduction period of the content, and TEperiod=“2” is described when the transition effect is applied at the start and end of the reproduction period.

According to the description as shown in FIGS. 5A and 5B, by reproducing the transition effect for each piece of content in which a moving image and audio are combined, it is possible to easily manage and access the content for each scene or the like where the scene changes.

The timing at which the transition effect is to be applied is set by the item TEperiod, but instead of this, the TEtime item may be provided as in FIG. 4, and the timing at which the transition effect is applied may be set by the value of TEtime.

When a moving image is used as media data to which a transition effect is to be applied, it is conceivable that there will be cases where it is difficult to grasp the content of the moving image being reproduced due to the transition effect, and it is conceivable that there will be cases where the reproduction environment will not be conducive to application of the transition effect to the moving image in the reproduction state. In consideration of such situations, the information processing apparatus 100 may use the moving image as the media data to which the transition effect is applied, or may pause the reproduction of the moving image during the application of the transition effect. The pause may be set so as to always be performed, or an item therefor may be separately provided thereof in a description of an attribute of the transition effect, and the pause may be set to be on or off by a parameter. When the moving image is paused by such a process, the reproduction time of the entire application time of the transition effect is extended, and when there is audio or the like to be reproduced concurrently, the reproduction time will be inconsistent. Therefore, when the moving image is paused, the information processing apparatus 100 may pause the audio at the same time, or may separately play a sound effect or the like while the moving image is paused. In addition, when the moving image is paused, the length of the audio may be set to a length in consideration of the time over which the moving image is to be paused.

In addition, for example, when it is desired to perform a crossfade in which the next image or audio is gradually reproduced while the image or audio is caused to fade, there will be a period in which previous and subsequent images or audio are simultaneously reproduced (overlapped). The generation unit 106 may specify whether or not to overlap the media data to be switched by applying the fade effect in this manner by a parameter. By such a description, it is possible to clearly define the reproduction state of each piece of media data with respect to a crossfade in which media data whose reproduction is switched is overlapped.

### Second Embodiment

In the first embodiment, each transition effect to be applied to the media data is separately described as with the content 505 and the content 506 and the like in FIGS. 5A and 5B, for example. The information processing apparatus 100 according to the second embodiment defines common parameters used for setting a plurality of transition effects, and sets each transition effect using defined parameters.

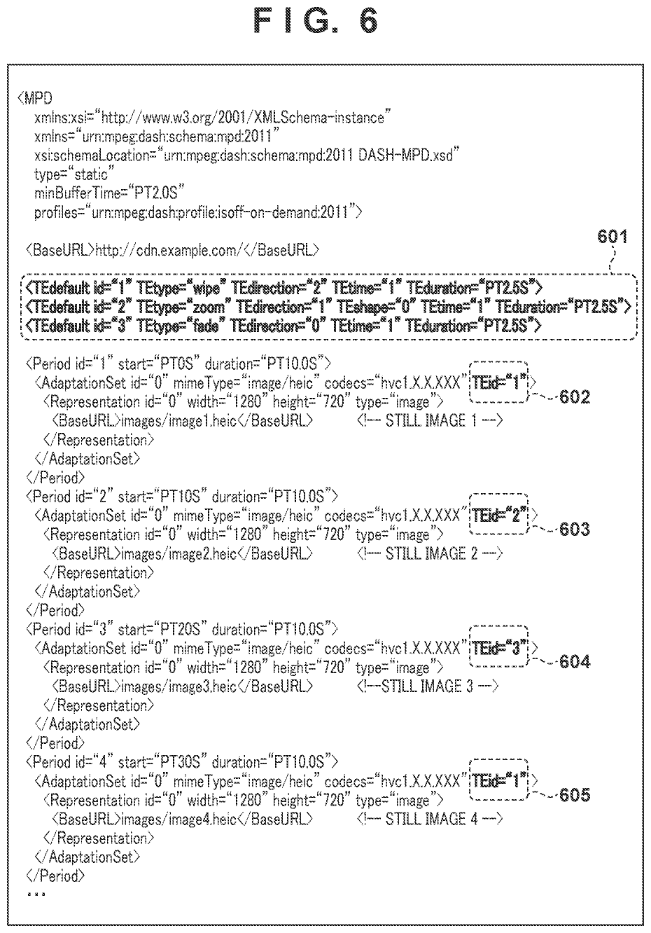

FIG. 6 is a diagram that illustrates an example of a portion of a description of a playlist generated by the generation unit 106 according to the present embodiment. FIG. 6 illustrates an exemplary description of a MPD file for when a slideshow in which images are displayed every 10 seconds is realized in MPEG-DASH, and a transition effect for when the display of an image is switched is defined for each image.

In FIG. 6, a description 601 for setting three transition effects is described. In the description 601, which media data (image) the transition effect corresponds to is described in an item TEdefault id indicating a parameter (ID) of an identifier for identifying a transition effect, and the ID is designated as 1, 2, and 3. For each group of media data or for each piece of media data, a corresponding media data ID is described in the descriptions 602 to 605 using the item TEid included in an AdaptationSet or a Representation or the like. TEid is applied to the entire group of media data included in an AdaptationSet when the TEid is described at the AdaptationSet level, and TEid is applied to media data included in a Representation when the TEid is described at the Representation level. In this case, a transition effect of ID 1 is applied to a still image 1, a transition effect of ID 2 is applied to a still image 2, a transition effect of ID 3 is applied to a still image 3, and the transition effect of ID 1 is applied to a still image 4. As described above, the generation unit 106 can set the transition effect by defining a common ID (parameter) used for setting a plurality of transition effects and describing such common parameters. If there is only one transition effect, there is no need to describe the ID because it is sufficient to merely have information that identifies whether or not to apply the transition effect.

According to such a description, even when there are a plurality of pieces of media data to which the same transition effect is to be applied, definition is possible simply by describing a common parameter with an ID to be referenced, and thus it is possible to reduce the amount of description.

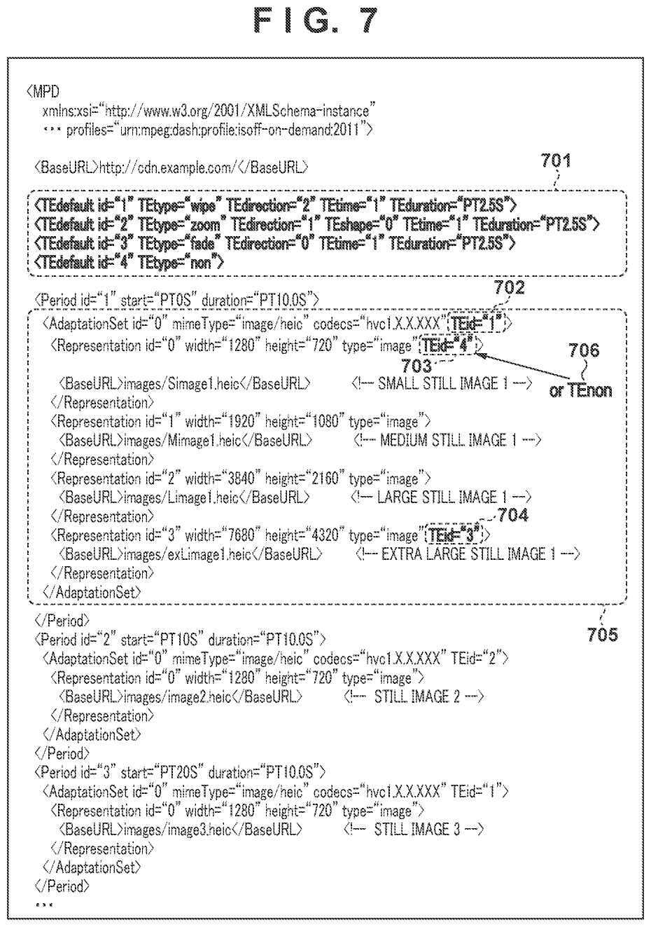

FIG. 7 is a diagram illustrating an exemplary description for when a transition effect is applied to a plurality of pieces of media data using an MPD mechanism. In a description 701 of FIG. 7, in addition to description similar to the description 601 of FIG. 6, an ID corresponding to the media data to which the transition effect is not to be applied is defined as “TEdefault=4”. For each piece of media data, a corresponding media data ID is described in descriptions 702 to 704 in an item TEid included in an AdaptationSet, Representation, or the like.

Among the media data included in an AdaptationSet group of media data, media data to which to apply a transition effect of a TEid other than the TEid described at the level of AdaptationSet can be separately described at the level of Representation. In the example of FIG. 7, the description 701 (“TEid=1”) is described as an ID at an AdaptationSet 705 level, but a description 703 (“TEid=4”) and a description 704 (“TEid=3”) are described for the two pieces of media data included within the AdaptationSet 705. Therefore, the transition effect is not applied to the image Simage.heic for which the description 703 is described, the transition effect of ID 3 is applied to the image exLimage.heic for which the description 704 is described, and the transition effect of ID 1 is applied to the rest of the images.

Although TEid=4 is described as being assigned as the ID in the case where a transition effect is not to be applied, configuration may be such that an ID is not assigned as in a description 706 (TEnone), for example, and rather information indicating that no transition effect be applied is described.

### Third Embodiment

It is conceivable that there will be cases where the transition effect defined in a playlist will be difficult to reproduce in a reproduction environment of the apparatus that has received the playlist. In consideration of such a case, the generation unit 106 may set other transition effects to be reproduced when a certain transition effect cannot be reproduced. The generation unit 106 can define a priority of a plurality of transition effects for the time of reproduction by the reception apparatus 200, and a transition effect of the next highest priority can be set to be reproduced for a transition effect that cannot be reproduced in the reception apparatus 200. In the following description, the priority of the transition effect may be referred to simply as the “priority”.

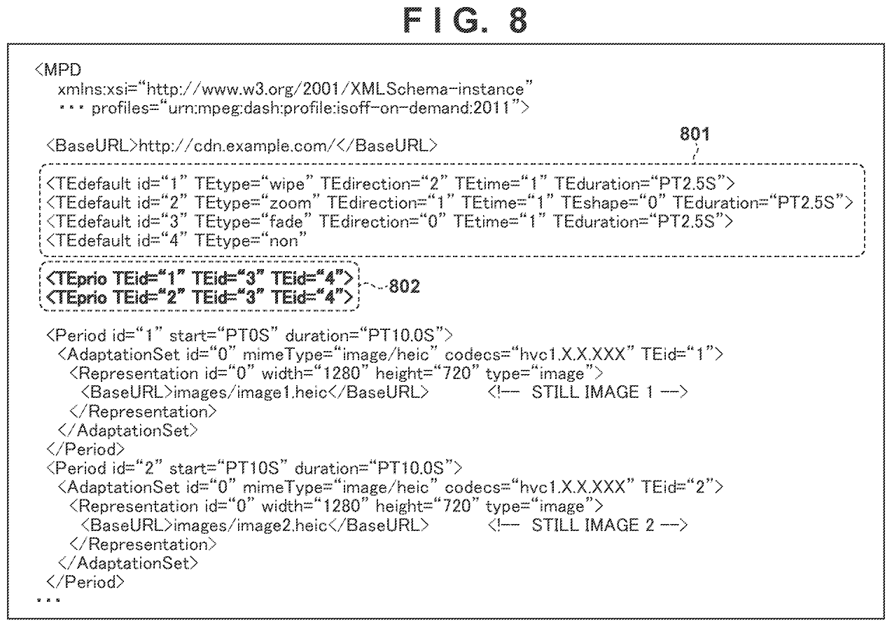

An example of a description defining the priority of the transition effect will be given with reference to FIG. 8. FIG. 8 is a diagram illustrating an example of a description for when a transition effect is applied to a plurality of pieces of media data using an MPD mechanism. A description 801 in FIG. 8 is similar to the description 701. A description 802 following the description 801 is a description defining priority. Here, information starting with the tag TEprio is a description indicating priority. In the example of FIG. 8, the transition effect IDs are listed in descending order of priority starting with the ID following TEprio. For example, by the description of “TEprio “TEid=1”, “TEid=3”, “TEid=4””, the priority is set to be ID 3 and then ID 4 in that order for the transition effect of ID 1. Therefore, when the transition effect of ID 1 cannot be reproduced, the transition effect of ID 3 is reproduced, and when the transition effect of ID 3 cannot be reproduced, the transition effect of ID 4 is reproduced, and when the transition effect of ID 4 cannot be reproduced, no transition effect is applied. Furthermore, by the description of “TEprio “TEid=2”, “TEid=3”, “TEid=4” in the next block down, the priority is set to be ID 3 and then ID 4 in that order for the transition effect of ID 2.

Although the ID descriptions are described as being listed in descending order of priority in the description 801, configuration may be such that a playlist is generated by a different method as long as the priority can be recognized, for example, a description in ascending order of priority. Also, the generation unit 106 may set the priority for each ID (here, for ID 1 and ID 2 separately) as in the description 802, or may set the common priority for everything. That is, the generation unit 106 may set a common priority for everything such that the priority is descending in the order of ID 1 to ID 4, for example.

In addition, there may be a combination of transition effects that have little effect even if they are replaced because the transition effects are similar effects. In consideration of this, the generation unit 106 may set a group (transition effect group) of transition effects that can be applied in place of each other, and generate a playlist so as to reproduce another transition effect of the transition effect group including a transition effect that cannot be reproduced.

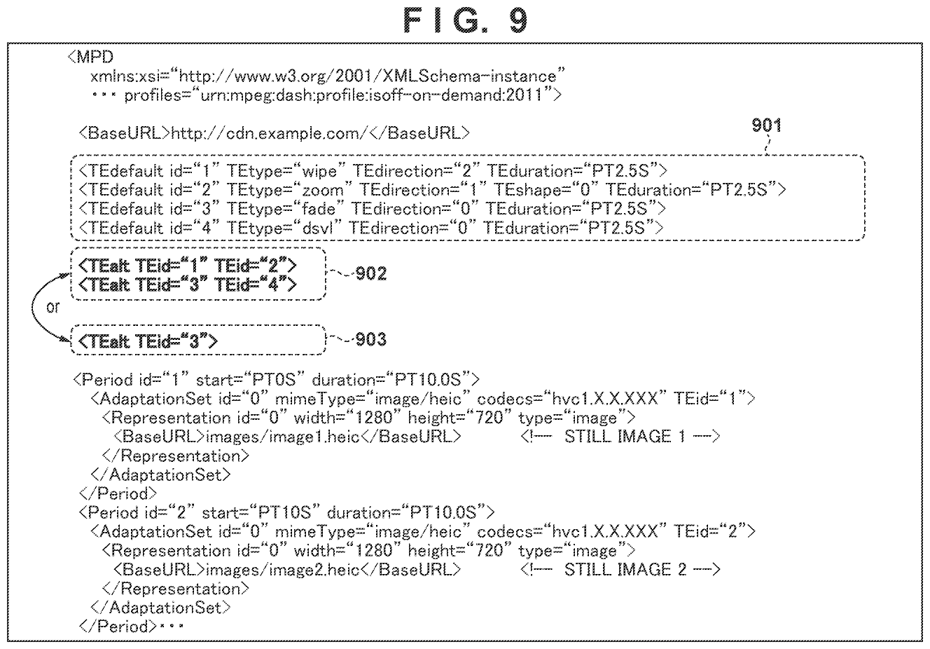

FIG. 9 is an example of a description of a playlist that sets such a group of transition effects that can be applied as alternatives (can be substituted). A description 901 in FIG. 9 is similar to the description 701. A description 902 following the description 901 is a description for setting a transition effect group. Here, a transition effect ID included in the transition effect group is described following the tag TEalt, and transition effects having the IDs 1 and 2 and the IDs 3 and 4 are set as groups, respectively. That is, the transition effect having the ID 1 and the transition effect having the ID 2 are transition effects that can be substituted for each other, and the transition effect having the ID 3 and the transition effect having the ID 4 are transition effects that can be substituted for each other. If all transition effects can be substituted for one type of transition effect, the ID of the one type of transition effect is assumed to be described following the tag TEalt as in a description 903. That is, the generation unit 106 can describe an ID for one type of transition effect that can be applied when any other transition effect cannot be applied.

In the example of FIG. 9, the transition effect group includes two transition effects that can be substituted for each other, but the transition effect group may include three or more transition effects. In this case, the generation unit 106 may set the priority of the transition effect for determining the alternative transition effect. The priority setting can be made similarly to as described with reference to FIG. 8, and so description thereof will be omitted.

### Fourth Embodiment

As discussed above, MPEG-DASH allows the reception apparatus 200 to acquire optimal versions of segments depending on its capabilities, the communication environment, and the like. Here, it is conceivable that the user will not notice a change in media data that is continuously switched even when media data having different quality (bit rate, resolution, sampling rate, band, coding format, or the like) is being acquired. In consideration of this, the information processing apparatus 100 can determine whether or not the quality changes between media data whose reproduction is switched, and can generate a playlist so as to apply the transition effect when it is determined that the quality changes.

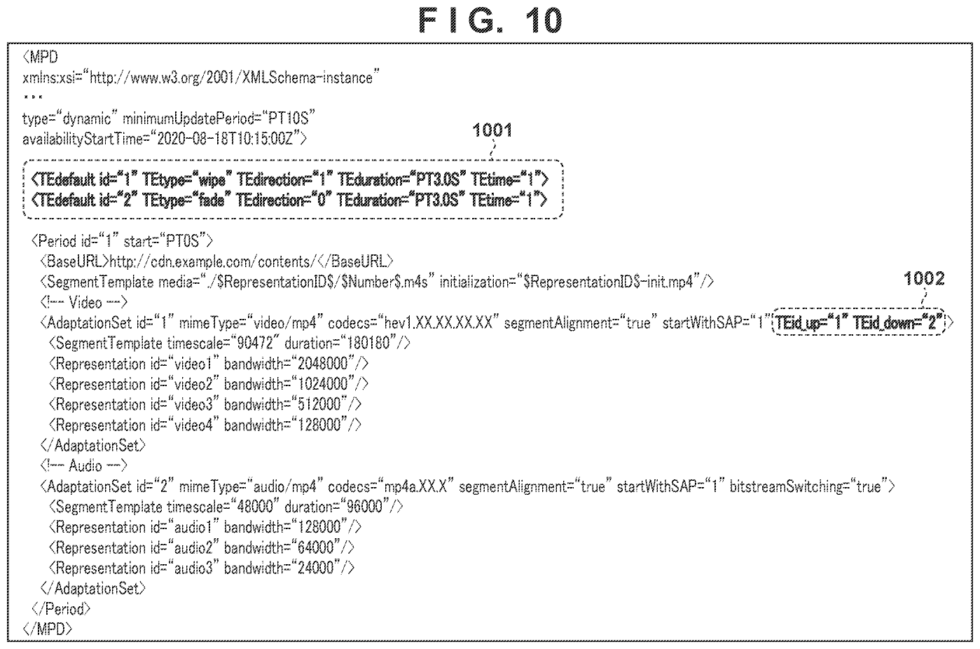

FIG. 10 is an example of a description of a playlist that is set to apply a transition effect when the quality of media data changes. Here, in particular, a transition effect when a Representation is switched is defined.

A description 1001 defines two transition effects. A description 1002 describes a condition setting for the transition effect described at the AdaptationSet level. In the example of FIG. 10, the description of “TEid_up=1” defines a transition effect with an ID 1 when the quality (here, bandwidth, bit rate) increases, and the description of “TEid_down=2” defines a transition effect with an ID of 2 when the quality decreases. Here, it is assumed that that the quality is determined to have changed when bandwidth changes (rises or falls) even slightly, but configuration may be such that a predetermined condition is provided, and the quality is determined to have changed when the amount that the bandwidth changes satisfies the condition. For example, the generation unit 106 may be configured such that the quality is treated as having changed when the amount that the bandwidth changes exceeds a predetermined ratio (e.g., 20%) of the value prior to the change, or configuration may be taken such that the quality is treated as having changed when the amount of change exceeds a predetermined value. Although bandwidth is used as a reference for quality change here, the present invention is not particularly limited thereto, and the aforementioned sampling rate or the like may instead be used, and if the media data is an image, the image size or the like may be used. It is assumed that a change in quality can be determined based on whether or not the value of any of the bit rate, the sampling rate, or the resolution has changed by a predetermined threshold or more, or whether or not the coding format has changed.

In addition, as described above, when determining that the quality changes, the generation unit 106 can generate the playlist so as to apply a different transition effect depending on whether the quality is increasing or decreasing. Here, the transition effect of the ID indicated by TEid_up is applied when the quality is increasing, and the transition effect of the ID indicated by TEid_down is applied when the quality is decreasing. Here, it is assumed that the quality has increased when each value serving as a quality criterion has increased, and the quality has decreased when each value has decreased.

According to such a process, the transition effect can be applied in accordance with a change in the quality of the media data to be switched. Therefore, it is possible not only to utilize the transition effect as a dramatic effect, but also to contribute to a reconsideration of the reception environment by applying a transition effect when the version of the acquired media changes.

### Fifth Embodiment

In the first to fourth embodiments, description has been given on the assumption that each process is performed on the side of the information processing apparatus 100 which transmits data to the reception apparatus 200. In the fifth embodiment, the processing on the reception apparatus 200 side will be described. That is, the reception apparatus 200 according to the present embodiment receives the playlist and acquires the media data based on network addresses included in the playlist. Next, the reception apparatus 200 reproduces the acquired media data based on the playlist.

In streaming technologies such as MPEG-DASH, the media data to be acquired can be decided by a determination by the reception apparatus in accordance with a processing capability of the reception apparatus, the communication environment, or the like. In consideration of this, the reception apparatus 200 according to the present embodiment can make a setting to perform alternative processing for a transition effect that cannot be applied among the transition effects described in the received playlist.

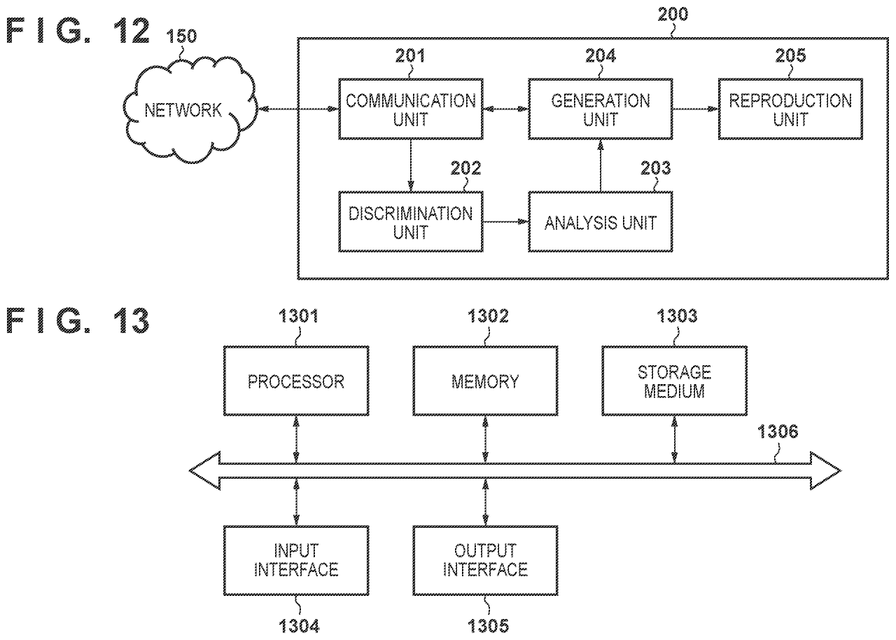

FIG. 12 is a block diagram illustrating an example of a functional configuration of the reception apparatus 200. The reception apparatus 200 includes a communication unit 201, an analysis unit 202, a determination unit 203, a setting unit 204, and a reproduction unit 205. The communication unit 201 receives the playlist generated by the generation unit 106 from the information processing apparatus 100.

The analysis unit 202 analyzes the description of the playlist received by the communication unit 201. Here, the determination unit 203 determines whether or not there is a transition effect to be applied to the media data in the description of the playlist. Next, when there is a transition effect in the description of the playlist, the determination unit 203 determines whether or not the transition effect can be applied. For example, the determination unit 203 may store the type of applicable transition effect, and determine whether or not the transition effect is applicable based on the item TEtype described in the playlist.

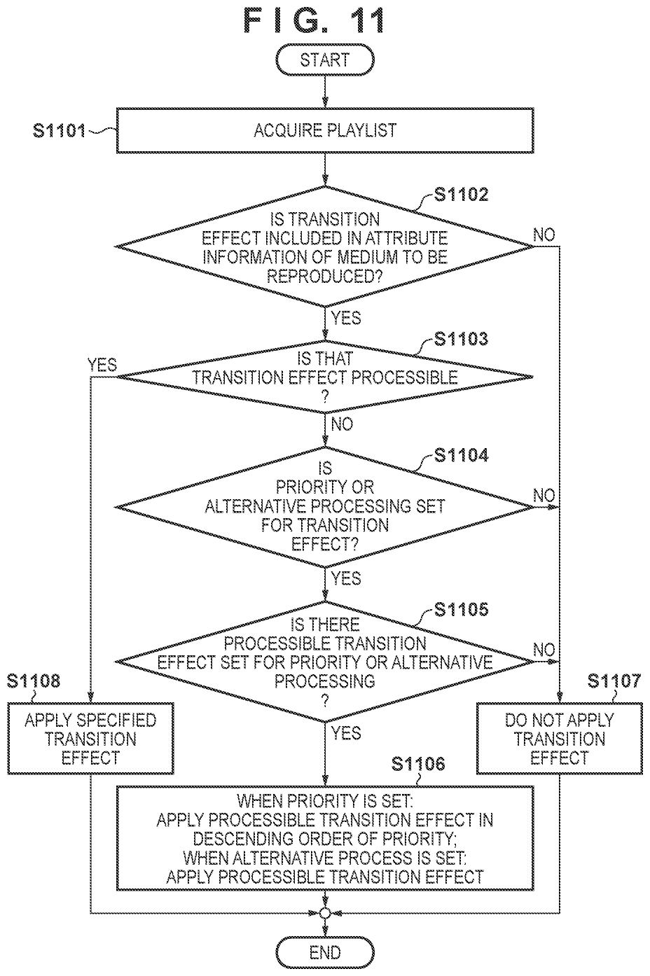

The setting unit 204 sets a transition effect to be applied to media data based on the result of determination by the determination unit 203. Here, when there is a transition effect that cannot be applied to the playlist, the setting unit 204 sets an alternative process for the application of the transition effect. An example of this processing will be described later with reference to FIG. 11.

The communication unit 201 may transmit a request to acquire media data to be reproduced to the information processing apparatus 100 based on the network address described in the playlist, and acquire the media data. In this case, the reproduction unit 205 can reproduce the media data corresponding to the playlist based on the media data acquired by the communication unit 201 and the transition effect set by the setting unit 204.

FIG. 11 is a flowchart illustrating an example of a process, performed by the reception apparatus 200 according to the present embodiment, for setting a transition effect to be applied to media data based on a playlist received from the information processing apparatus 100.

In step S1101, the communication unit 201 acquires a playlist from the information processing apparatus 100. In step S1102, the analysis unit 202 analyzes the playlist, and the determination unit 203 determines whether or not the attributes of the media data to be reproduced include transition effect information. If the attributes do include transition effect information, the process proceeds to step S1103; otherwise, the process proceeds to step S1107. Note that step S1102 to step S1108 described below are assumed to be performed for a transition effect corresponding to one piece of media data to be processed, but when there are a plurality of pieces of media data, a similar process can be performed for each piece of media data.

In step S1103, the determination unit 203 determines whether or not a transition effect included in the transition effect information can be applied to the reception apparatus 200. If a transition effect can be applied, the process proceeds to step S1108; otherwise, the process proceeds to step S1104.

In step S1104, the determination unit 203 determines whether or not an alternative process to be executed when the transition effect described in the playlist cannot be applied is set. If an alternative process is set, the process proceeds to step S1105; otherwise, the process proceeds to step S1107. Here, for example, it is possible to determine whether or not an alternative process is set by determining whether or not a priority as described with reference to FIG. 8 or a group of transition effects that can be substituted as described with reference to FIG. 9 are described in the playlist. Further, for example, in a case where the reception apparatus 200 already has a setting for alternative processing, the setting may be referenced.

In step S1105, the determination unit 203 determines whether or not the set alternative process can be executed by the reception apparatus 200. If the set alternative process can be executed, the process proceeds to step S1106; otherwise, the process proceeds to step S1107. Here, as an alternative process, the determination unit 203 determines whether or not the transition effect can be applied in the reception apparatus 200 when a process for applying a transition effect that can be substituted has been set.

In step S1106, the setting unit 204 sets a process determined to be executable in step S1105 as the above-described alternative process. Here, the setting unit 204 can set a transition effect having the highest priority among the transition effects that can be substituted for the transition effects described in the playlist as the transition effect to be actually applied. When the process of step S1106 is completed, the process according to FIG. 11 ends.

In step S1107, the setting unit 204 sets the transition effect to not be applied to the media data to be processed, and ends the processing. In step S1108, the setting unit 204 sets the transition effect described in the playlist to be applied to the media data to be processed, and ends the processing.

According to such processing, it is possible to acquire media data based on a network address included in a received playlist and reproduce the acquired media data based on the playlist by the processing on the reception apparatus side. In particular, a transition effect that cannot be applied among the transition effects described in the received playlist can be set to perform alternative processing.

### Sixth Embodiment

In the above-described embodiment, each processing unit illustrated in FIG. 2 and FIG. 12, for example, is realized by dedicated hardware. However, some or all of the processing units included in the information processing apparatus 100 or the reception apparatus 200 may be realized by a computer. In the present embodiment, at least a part of the processing according to each of the above-described embodiments is executed by a computer.

FIG. 13 is a diagram illustrating a basic configuration of a computer. In FIG. 13, a processor 1301 is, for example, a CPU, and controls the operation of the entire computer. A memory 1302 is, for example, a RAM, and temporarily stores programs, data, and the like. A computer-readable storage medium 1303 is, for example, a hard disk or a CD-ROM, and stores programs, data, and the like over a long period of time. In the present embodiment, a program for realizing the functions of the respective units stored in the storage medium 1303 is read out to the memory 1302. The processor 1301 operates in accordance with a program on the memory 1302, thereby realizing the functions of the respective units.

In FIG. 13, an input interface 1304 is an interface for acquiring information from an external apparatus. Also, an output interface 1305 is an interface for outputting information from an external apparatus. A bus 1306 connects the above-described units and enables data exchange. The configuration of the computer can be adopted in both the information processing apparatus 100 and the reception apparatus 200. Note that the configuration of the information processing apparatus 100 and the reception apparatus 200 need not be the same.

### OTHER EMBODIMENTS

Although embodiment examples have been described in detail above, the present invention can be embodied as, for example, a system, an apparatus, a method, a program, a recording medium (storage medium), or the like. Specifically, the present invention may be applied to a system configured to include a plurality of devices (for example, a host computer, an interface device, an imaging device, a web application, and the like), or may be applied to an apparatus made up of one device.

The present invention is also achieved by supplying a software program that realizes the functions of the above-described embodiments directly or remotely to a system or apparatus, and a computer of such a system or apparatus reads and executes the supplied program code. The program in this case is a computer-readable program corresponding to a flowchart illustrated in the drawings in the embodiment.

Accordingly, the program code itself which is installed in the computer to allow the computer to implement the functions/processing of the present invention also implements the present invention. That is, the present invention also encompasses the computer program itself for implementing the functional processing of the present invention.

As long as the function of a program is achieved, the form of the program may be object code, a program to be executed by an interpreter, script data to be supplied to an OS, or the like.

Examples of the recording medium for supplying the program include the following media. Examples thereof include a Floppy® disk, a hard disk, an optical disk, a magneto-optical disk, an MO, CD-ROM, CD-R, CD-RW, a magnetic tape, a non-volatile memory card, and a ROM, a DVD (DVD-ROM or DVD-R) and the like.

As a method of supplying the program, the following method is also possible. A browser of a client computer may connect to a homepage on the Internet, and a computer program for the present invention itself (or a file that is compressed and includes an automatic installation function) is downloaded therefrom to a recording medium such as a hard disk. Further, the present invention can also be realized by dividing program code constituting a program for the present invention into a plurality of files and downloading the respective files from different homepages. That is, the present invention also encompasses a WWW server that allows a plurality of users to download a program file for realizing the functional processing of the present invention by a computer.

In addition, the program of the present invention may be encrypted and stored in a storage medium such as a CD-ROM and distributed to a user, and a user who meets predetermined conditions may be allowed to download key information for decryption from a homepage on the Internet. That is, the user can execute the encrypted the program by using the key information and thereby install the program on the computer.

Further, functions of the above-described embodiments are realized by the computer executing a read program. Further, an OS or the like running on a computer can perform some or all of the actual processing based on instructions of the program, and the functions of the above-described embodiments can also be realized by such processing.

Further, functions of the above-described embodiments can also be realized by a program read from the recording medium being written into a memory provided in a function expansion board inserted into the computer or a function expansion unit connected to the computer and then executed. That is, a CPU or the like provided in a function expansion board or a function expansion unit can perform some or all of the actual processes based on instructions of the program.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-145570, filed Sep. 13, 2022, which is hereby incorporated by reference herein in its entirety.

What is claimed is:

1. An information processing apparatus comprising:
a generation unit configured to generate a playlist including a network address to be referenced in order to acquire first media data and second media data to be reproduced subsequently to the first media data and transition effect information indicating a first transition effect to be applied to a display or audio when switching reproduction of the first media data and the second media data; and
a transmission unit configured to transmit the playlist to the reception apparatus.

2. The information processing apparatus according to claim 1, wherein the transition effect information is information indicating a type of the first transition effect or a setting of the first transition effect.

3. The information processing apparatus according to claim 2, wherein the setting of the first transition effect includes a timing at which to apply the first transition effect or a period over which to apply the first transition effect.

4. The information processing apparatus according to claim 3, wherein the timing at which to apply the first transition effect is when reproduction of the first media data ends, when reproduction of the second media data starts, or both when reproduction ends and when reproductions starts.

5. The information processing apparatus according to claim 2,
further comprising a definition unit configured to define a common parameter to be used for setting a plurality of transition effects, wherein
the generation unit describes information indicating the setting of the first transition effect by the common parameter.

6. The information processing apparatus according to claim 2, wherein
the type of the first transition effect includes
an effect in which, when reproduction of the first media data, which is an image, and the second media data, which is an image, is switched, the first media data disappears in a predetermined direction or the second media data appears from a predetermined direction;
an effect in which, when reproduction of the first media data, which is an image, and the second media data, which is an image, is switched, the first media data shrinks in a predetermined direction or the second media data is enlarged in a predetermined direction; or
an effect in which, when reproduction of the first media data, which is an image or audio, and the second media data, which is an image or audio, is switched, the first media data fades out or the second media data fades in.

7. The information processing apparatus according to claim 6, wherein
in a case where the type of the first transition effect is the effect in which the first media data fades out or the second media data fades in,
the transition effect information further includes information indicating whether or not the first media data and the second media data are caused to be overlapped.

8. The information processing apparatus according to claim 1, wherein the first transition effect is applied to a display or audio when switching reproduction of content including the first media data and media data different to the first media data, and reproduction of content including the second media data and media data different to the second media data.

9. The information processing apparatus according to claim 1, wherein the transition effect information further includes information indicating a third transition effect applied in a case where the first transition effect cannot be applied in the reception apparatus.

10. The information processing apparatus according to claim 1, wherein the transition effect information further includes information indicating a type of transition effect which can be applied in a case where another transition effect cannot be applied in the reception apparatus.

11. The information processing apparatus according to claim 1, wherein the generation unit describes the transition effect information by using a parameter for identifying the first transition effect for each piece of media data to which the first transition effect is to be applied.

12. The information processing apparatus according to claim 1,
further comprising a determination unit configured to determine whether or not a quality changes between the first media data and the second media data, wherein
the first transition effect is applied to the display or audio in a case where it is determined that the quality changes between the first media data and the second media data.

13. The information processing apparatus according to claim 12, wherein the determination unit makes a determination as to whether the quality changes, based on a change in a bit rate, a sampling rate, a resolution, or a coding format of the first media data and the second media data.

14. The information processing apparatus according to claim 1, wherein the playlist is described in a file compliant with the ISO/JEC 23009-1 standard.

15. A reception apparatus, comprising:
a reception unit configured to receive a playlist including a network address to be referenced in order to acquire first media data and second media data to be reproduced subsequently to the first media data and transition effect information indicating a transition effect to be applied to a display or audio when switching reproduction of the first media data and the second media data; and
an acquisition unit configured to acquire, based on the network address, the first media data and the second media data; and
a reproduction unit configured to, based on the received playlist, perform reproduction of the acquired first media data and second media data.

16. The reception apparatus according to claim 15, further comprising:
a determination unit configured to determine whether or not the transition effect, which is included in the transition effect information, can be applied in the reception apparatus; and
a setting unit configured to, in a case where the transition effect cannot be applied, set alternative processing for application of the transition effect.

17. An information processing method for the information processing apparatus according to claim 1 comprising:
generating a playlist including a network address to be referenced in order to acquire first media data and second media data to be reproduced subsequently to the first media data and transition effect information indicating a first transition effect to be applied to a display or audio when switching reproduction of the first media data and the second media data; and
transmitting the playlist to the reception apparatus.

18. An information processing method for the reception apparatus according to claim 15 comprising:
receiving a playlist including a network address to be referenced in order to acquire first media data and second media data to be reproduced subsequently to the first media data and transition effect information indicating a transition effect to be applied to a display or audio when switching reproduction of the first media data and the second media data; and
acquiring, based on the network address, the first media data and the second media data; and
performing, based on the received playlist, reproduction of the acquired first media data and second media data.

19. A non-transitory computer readable storage medium on which is stored a computer program for making a computer execute a method for the information processing apparatus according to claim 1, the method comprising:
generating a playlist including a network address to be referenced in order to acquire first media data and second media data to be reproduced subsequently to the first media data and transition effect information indicating a first transition effect to be applied to a display or audio when switching reproduction of the first media data and the second media data; and
transmitting the playlist to the reception apparatus.

20. A non-transitory computer readable storage medium on which is stored a computer program for making a computer execute a method for the reception apparatus according to claim 15, the method comprising:
receiving a playlist including a network address to be referenced in order to acquire first media data and second media data to be reproduced subsequently to the first media data and transition effect information indicating a transition effect to be applied to a display or audio when switching reproduction of the first media data and the second media data; and
acquiring, based on the network address, the first media data and the second media data; and
performing, based on the received playlist, reproduction of the acquired first media data and second media data.
